(19) United States
(12) Patent Application Publication
(10) Pub. No.: US 2026/0092615 A1
(43) Pub. Date: Apr. 2, 2026

(54) CONNECTING ARRANGEMENT FOR CONNECTING COMPONENTS AND VEHICLE DEVICE

(71) Applicant: Witte Automotive GmbH, Velbert (DE)

(72) Inventors: Jan Christian BENTE, Sprockhövel (DE); Harry PURWIN, Ratingen (DE)

(21) Appl. No.: 19/344,744

(22) Filed: Sep. 30, 2025

(30) Foreign Application Priority Data
Oct. 2, 2024 (DE) 10 2024 209 694.6

(51) Int. Cl. F16B 4/00

(52) U.S. Cl. CPC F16B 4/004

(57) ABSTRACT

A connecting arrangement for connecting two components may have at least one connecting unit, a nut element, and a screw element. The connecting unit may have an interface for coupling to a first component. The coupling interface may have at least two coupling portions for coupling to the first component. The connecting arrangement may be fixed to the first component in a form-fitting manner without play by means of the at least two coupling portions. A vehicle device may have the connecting arrangement.

### FIELD

The invention relates to a connecting arrangement for connecting components and to a vehicle device having such a connecting arrangement.

### BACKGROUND

Vehicles have a variety of connecting arrangements for connecting two components, such as a piece of trim on a vehicle panel, a vehicle light on a vehicle panel, or the like. Parts of connecting arrangements and/or the components themselves are increasingly made of plastic materials. Due to mechanical stresses on the connecting arrangement caused by load and tension, time- and temperature-dependent plastic deformation of the components can occur due to so-called creep behavior (also called flow behavior) of the plastic materials.

The object of the present invention is to provide a connecting arrangement (also referred to as a connecting apparatus) for connecting two components, and a vehicle device having such a connecting arrangement, which at least reduces or compensates for such creep.

The first object is achieved according to the invention by a connecting arrangement having the features of claim 1. The second object is achieved according to the invention by a vehicle device having the features of claim 15.

The dependent claims relate to advantageous developments.

The connecting arrangement according to the invention for connecting at least two components comprises at least one connecting unit and a nut element, wherein the connecting unit has an interface for coupling to a first component and optionally a surface for contact with a second component, wherein the coupling interface comprises at least two coupling portions for coupling to the first component, wherein the connecting arrangement can be fixed, in particular pre-fixed, to the first component in a form-fitting and/or force-fitting manner by means of the at least two coupling portions.

The connecting unit comprises in particular at least one base element and a compensating element which is in threaded engagement with the base element in order to compensate for tolerances, in particular component tolerances, such as radial and/or axial tolerances.

In particular, the connecting unit can be fixable, in particular pre-fixable, or fixed, in particular pre-fixed, to the first component by means of the at least two coupling portions without play.

The coupling interface between the connecting unit and the first component can in particular be designed to be such a form-fitting and/or force-fitting coupling interface without play that all external forces acting upon the connecting arrangement are transmitted via the coupling interface.

For example, the coupling interface can be pre-fixable to the first component without play in at least two spatial directions by means of the at least two coupling portions. In particular, the connecting unit can be directly connected to the first component in a form-fitting and/or force-fitting manner via the coupling portions.

### SUMMARY

In this case, in order to be pre-assembled and pre-connected to the first component and to be connected thereto in a form-fitting/force-fitting manner without play in at least two spatial directions, in particular in the z-direction and in the x-direction, the coupling interface can have a coupling portion, which can be assigned to a counter-coupling portion on the first component so that a form-fitting connection without play can be formed with the first component, in particular both in the z-direction and in the x-direction.

Preferably, the connecting unit, formed from a base element and a compensating element, is designed such that it can be pre-assembled on the first component (also called interface, in particular customer interface) with an axial offset in a spatial direction.

For example, the connecting unit can be pre-assembled in and/or on the first component by means of the coupling portions in such a way that an axial offset is formed in at least one spatial direction between the connecting unit and an interface opening in the first component and/or between a screw element to be inserted and the interface opening. The axial offset is understood to mean an offset of the longitudinal axis of the connecting unit with respect to the longitudinal axis of the first component in a spatial direction-for example, in the x-direction. The axial offset is therefore a parallel offset.

When connecting the two components, in particular when inserting the screw element, the latter extends through the connecting unit and at least partially into the interface opening in the first component as a result of the axial offset. Alternatively or additionally, the screw element may abut an edge of the interface opening in the first component as a result of the axial offset.

When connecting the two components, the second component is then positioned without play relative to the first component (=interface) using the connecting unit. For example, when connecting the two components, in order to center the connecting unit and/or screw element relative to the first component and to eliminate the axial offset, the second component and/or the screw element, and together therewith the connecting unit, can be pushed into a central position relative to the interface opening. This then allows the screw element to be inserted into the interface opening and screwed into the nut element. As a result, the second component is positioned without play relative to the first component.

Furthermore, the connecting unit can be fixable to the first component without play along for example all three axes by means of the coupling portions when fixing the screw element to the nut element and/or when connecting the two components.

In other words, when the two components are connected, the axial offset between the connecting unit and the first component is compensated for. The second component is locked to the first component in the spatial direction of the axial offset via the connecting unit. In particular, when the two components are connected, the second component is prevented from moving in the opposite direction, in particular in the −x-direction, to the spatial direction of the axial offset. Thus, the second component can no longer be removed from, in particular pushed out of, the first component in the −x-direction.

The connecting unit can be clamped to the nut element by means of the screw element. In particular, the screw element can clamp the second component, the connecting unit, and the nut element together. As a result, the first component is not in the force flow of the screw element.

In other words, in the assembled state in which the two components are connected by means of the connecting unit, the connecting unit and the resulting compensating element and the base element are clamped to the nut element by means of the screw element and are located in the force flow of the screw element and nut element between the two components. The preload is transferred directly from the nut element to the connecting unit, in particular the base element, so that the coupling portions of the connecting unit are not in the force flow of the screw element and the nut element, and thus not in the force flow of the preload.

An operating force acting upon the connection then acts upon the form-fitting and/or force-fitting connection between the first component and the connecting unit, in particular the base element.

In other words, the connecting arrangement can be configured such that all external forces acting upon the connecting arrangement are transmitted via the coupling interface and thus via the coupling between the connecting unit and the first component, in particular via the form-fitting/force-fitting, play-free connection between the coupling portion and the first component. In other words, all external forces (also called operating forces) are absorbed by the coupling interface. No preload from the screw element acts upon the coupling interface. Thus, the loss of preload is eliminated by including the interface. This ensures that the connection is durable. The preload only acts upon the nut element.

For example, each coupling portion can be wedge-shaped. Each counter-coupling portion on the first component can be designed, for example, as a cut-out, a recess, and/or a rear-engaging portion. In this way, a rear-engaging, in particular form-fitting, pre-connection between the connecting unit and the first component can be formed.

The shape of each coupling portion can, for example, be trapezoidal, wedge-shaped, L-shaped, T-shaped, dovetail-shaped, or the like. The shape of the rear-engaging portion or the shape of the cut-out/recess in the counter-coupling interface can, for example, be wedge-shaped, groove-shaped, dovetail groove-shaped, or the like.

In particular, when coupled, the coupling interface and the counter-coupling interface can form a form-fitting and/or force-fitting connection, e.g., a dovetail connection-for example, by wedge-shaped pin (dovetail/tenon) in a matching cut-out/recess (tail-groove/mortise).

In this case, the coupling portions of the connecting unit and the corresponding counter-coupling portions on the first component can be designed in particular such that, when the connecting unit is assembled on the first component, the connecting unit and the first component are connected without play in all three spatial directions, in particular in the longitudinal direction, vertical direction, and transverse direction, and thus in all three axial directions. In particular, when being pre-assembled on the first component, the connecting unit is pressed into a cavity in the first component along all three spatial directions so that existing tolerances will be or are compensated for, and the connecting unit is pre-assembled on the first component without play and thus without freedom of movement.

For example, the coupling portions of the connecting unit and the corresponding counter-coupling portions on the first component can be designed in particular to form a connection that creates a clamp. In particular, these can form a connection with one another that creates a wedge clamp-for example, a dovetail connection, an undercut connection, or the like.

In addition, the connecting unit can be pre-fixable to the first component so as to be axially offset to the longitudinal axis of the first component. As a result, the screw element and/or the second component pushes or presses against the first component when the components are connected, and thereby presses the first component against the connecting unit and thus adjusts them without play in relation to one another. In particular, the first component and the connecting unit are thereby locked together.

The nut element can, for example, be arranged in a free space between the connecting unit and the first component. The nut element can be formed separately. Alternatively, the nut element can be an integrated part of the connecting unit or the first component.

The advantages achieved by the invention consist, in particular, in the fact that flow behavior or creep of parts of the connecting arrangement, in particular in the region of the coupling interface between the connecting unit and the first component, e.g., in the region of an overmolded fastening nut, is at least reduced or even avoided.

### DESCRIPTION OF THE FIGURES

Exemplary embodiments of the invention are explained in greater detail with reference to the drawings, in which:

FIG. 1 schematically shows an exploded view of a connecting arrangement and a first component,

FIG. 2 schematically shows a perspectival view of a pre-assembled connecting arrangement,

FIG. 3 schematically shows an exploded view of the pre-assembled connecting arrangement and the first component,

FIG. 4 schematically shows a perspectival view of the pre-assembled connecting arrangement, which is in turn pre-assembled on the first component without play,

FIG. 5 schematically shows a cross-section of the connecting arrangement pre-assembled on the first component as per FIG. 4 and positioned on a second component,

FIG. 6 schematically shows a cross-section of the insertion of a screw element for connecting the two components by means of the connecting arrangement according to FIG. 5,

FIG. 7 schematically shows a cross-section of the connection between the connecting unit and the first component, which creates a clamp, in particular a wedge clamp, when connecting the two components,

FIG. 8 schematically shows an enlarged section of the cross-section according to FIG. 7 in the region of the coupling portion of the connecting unit and the first component, wherein the connecting arrangement is clamped to the first component without play and in a manner in which tolerances are compensated for,

FIG. 9 schematically shows a cross-section of the two components that are connected to one another without play in a manner in which tolerances are compensated for and in which portions thereof are clamped,

FIG. 10 schematically shows a sectional view of the coupling portion between the connecting unit and the first component,

FIG. 11 schematically shows a further sectional view of the coupling portion between the connecting unit and the first component,

FIG. 12 schematically shows an enlarged perspectival view of a wedge-shaped coupling portion on the connecting unit,

FIG. 13 schematically shows an enlarged perspectival view of a further wedge-shaped coupling portion on the connecting unit,

FIG. 14 schematically shows an enlarged perspectival view of a further wedge-shaped counter-coupling portion on the first component,

FIG. 15 schematically shows an enlarged sectional view of the play-free, clamped connection between a first coupling portion and a first counter-coupling portion,

FIG. 16 schematically shows an enlarged sectional view of the play-free, clamped connection between a second coupling portion and a second counter-coupling portion,

FIG. 17 schematically shows a sectional view of the connected components with a first force flow,

FIG. 18 schematically shows a further sectional view of the connected components with a first force flow,

FIG. 19 schematically shows a sectional view of an alternative connecting arrangement,

FIG. 20 schematically shows a perspectival view of the alternative connecting arrangement,

FIG. 21 schematically shows a sectional view of a further alternative connecting arrangement,

FIG. 22 schematically shows a perspectival view of the further alternative connecting arrangement,

FIG. 23 schematically shows a perspectival view of a further alternative connecting arrangement,

FIG. 24 schematically shows a perspectival view of a further connecting unit having alternative coupling portions,

FIG. 25 schematically shows a further perspectival view of the further connecting unit according to FIG. 24,

FIG. 26 schematically shows a sectional view of the further connecting unit according to FIG. 24,

FIG. 27 schematically shows an exploded view of the further connecting unit according to FIG. 24 and a first component,

FIG. 28 schematically shows a perspectival view of the further connecting unit and the first component when coupled, and

FIG. 29 schematically shows a method sequence for connecting the second component to the connecting unit and the first component.

### DETAILED DESCRIPTION

Parts corresponding to one another are provided with the same reference signs in all figures.

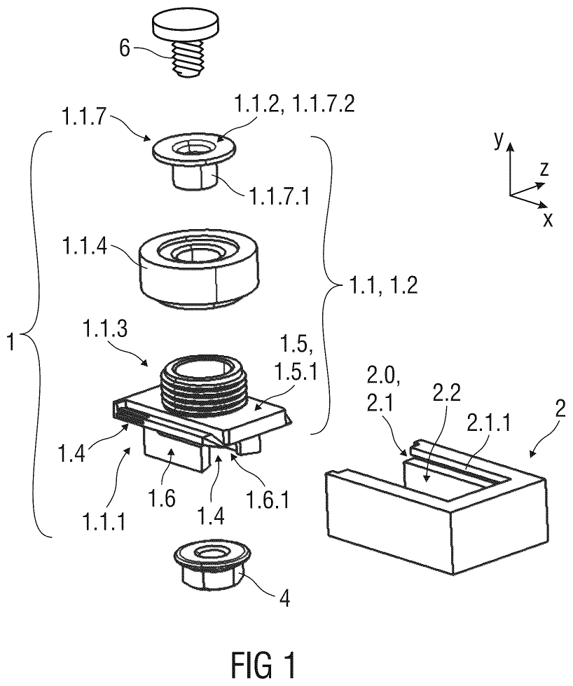

FIG. 1 schematically shows an exploded view of a connecting arrangement 1 and a first component 2.

The connecting arrangement 1 is designed as a tolerance-compensating apparatus. The connecting arrangement 1 comprises a connecting unit 1.1, which is designed as a tolerance-compensating element 1.2. Alternatively, the connecting unit 1.1 can also be designed as a screw connection.

The connecting arrangement 1 comprises the connecting unit 1.1, a nut element 4, and a screw element 6, in particular a threaded bolt or a connecting screw.

The connecting unit 1.1 has an interface 1.1.1 for coupling to the first component 2 and a surface 1.1.2 for contact with a second component 8 (shown in FIG. 5).

The coupling interface 1.1.1 can comprise at least two coupling portions 1.4 for coupling to the first component 2. The connecting arrangement 1 can be pre-fixed to the first component 2 in a form-fitting manner without play by means of the at least two coupling portions 1.4. For example, the coupling interface 1.1.1 can be pre-fixed to the first component 2 in a form-fitting manner and without play in at least two spatial directions by means of the at least two coupling portions 1.4. In particular, the connecting unit 1.1 can be directly connected to the first component 2 in a form-fitting and force-fitting manner via the coupling portions 1.4.

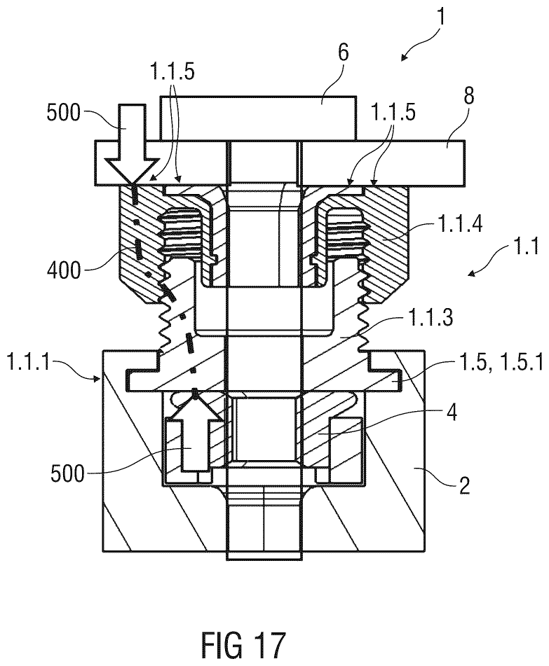

The connecting unit 1.1 can also be clamped to the nut element 4 by means of the screw element 6. In particular, the screw element 6 can clamp the second component 8, the connecting unit 1.1, and the nut element 4 together. As a result, the first component 2 is not in the force flow of the screw element 6, as shown in FIG. 17.

The coupling interface 1.1.1 is designed for pre-assembly on and pre-connection to the first component 2 in at least two spatial directions, in particular in the transverse direction z and in the longitudinal direction x. For this purpose, the coupling interface 1.1.1 has at least one coupling portion 1.4, which can be assigned to a corresponding counter-coupling portion 2.1 on the first component 2, so that a form-fitting connection to the first component 2 can be formed without play.

For example, each coupling portion 1.4 can be wedge-shaped. Each counter-coupling portion 2.1 on the first component 2 can be designed, for example, as a cut-out and/or a rear-engaging portion, in particular as a groove 2.1.1. In this way, a rear-engaging, in particular form-fitting, pre-connection between the connecting unit 1.1 and the first component 2 can be formed.

In particular, the coupling interface 1.1.1 and the counter-coupling interface 2.0 can form a form-fitting connection when coupled, e.g., a dovetail connection—for example, by wedge-shaped pins in a matching cut-out/recess (tails).

Each coupling portion 1.4 can, for example, be trapezoidal, wedge-shaped, L-shaped, T-shaped, dovetail-shaped, or the like. The rear-engaging portion or the cut-out in the counter-coupling portion 2.1 can, for example, be wedge-shaped, groove-shaped, dovetail groove-shaped, or the like.

In this case, the coupling portions 1.4 of the connecting unit 1.1 and the corresponding counter-coupling portions 2.1 on the first component 2 can be designed in particular such that, when the connecting unit 1.1 is assembled on the first component 2, the connecting unit 1.1 and the first component 2 are connected without play in all three spatial directions, in particular in the longitudinal direction x, vertical direction y, and transverse direction z, and thus in all three axial directions.

In particular, for this purpose, the connecting unit 1.1 is pressed into a cavity 2.2 in the first component 2 in all three spatial directions when pre-assembled on the first component 2, so that existing tolerances 200 (shown in FIG. 5) will be or are compensated for, and the connecting unit 1.1 is pre-assembled on the first component 2 without play and thus without freedom of movement.

For example, the coupling portions 1.4 of the connecting unit 1.1 and the corresponding counter-coupling portions 2.1 on the first component 2 can be designed in particular to form a connection with one another that creates a clamp, in particular a wedge clamp-for example, a dovetail connection, an undercut connection, or the like.

The connecting arrangement 1 designed as a tolerance-compensating apparatus serves to connect two components 2 and 8 (shown in FIG. 5) while compensating for tolerances 200, in particular axial and/or radial tolerances 200 (shown in FIG. 5).

The connecting arrangement 1 is used/installed, for example, in a vehicle in order to connect two components 2, 8, in particular vehicle components such as a headlight and a vehicle panel, in particular in order to connect a headlight to a vehicle panel (also called vehicle skin) while compensating for tolerances 200.

The connecting unit 1.1 designed as a tolerance-compensating element 1.2 comprises at least one base element 1.1.3, in particular a hollow-cylindrical sleeve with an internal thread or an external thread, and a compensating element 1.1.4, which is in threaded engagement with the base element 1.1.3, wherein the compensating element 1.1.4 is movable by being rotated relative to the base element 1.1.3 to compensate for the tolerances 200.

The base element 1.1.3 comprises an integrated retaining portion 1.5. The retaining portion 1.5 is designed as an integrated retaining carriage 1.5.1, which can be movably, in particular slidably, inserted into the first component 2. In addition, the base element 1.1.3 comprises a receiving portion 1.6 with a receiving cavity 1.6.1 into which the nut element 4 can be inserted.

In addition, the connecting unit 1.1 comprises a drive element 1.1.7. The drive element 1.1.7 is designed as an entraining element. The drive element 1.1.7 can also simultaneously be designed as a seal. In particular, the drive element 1.1.7 is designed as a separate plastic element. In section, the drive element 1.1.7 is T-shaped with a cylindrical entraining portion 1.1.7.1 and a flange 1.1.7.2 serving as a contact surface 1.1.2. The drive element 1.1.7 is elastic, such that it is also designed as an entraining element or entraining spring for the compensating element 1.1.4.

The tolerance-compensating element 1.2 is a conventional compensating element 1.1.4, as described, for example, in the older application, DE 10 2023 205 661.5.

The pre-assembled connecting arrangement 1 is pre-assembled on the first component 2 without play, as described in detail below with reference to the other figures, and is then positioned relative to the second component 8, or, vice versa, the second component 8 is positioned relative to the connection arrangement 1 in order to connect it.

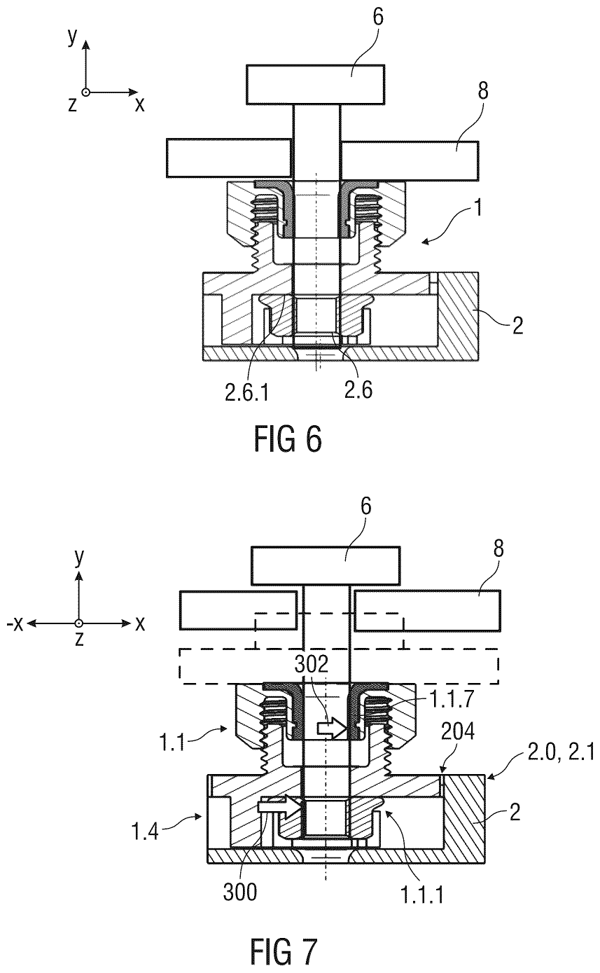

Subsequently, the screw element 6 for screwing the components 2 and 8 is guided through correspondingly provided openings in the components 2 and 8 and through the connecting arrangement 1 (as shown in FIG. 6). When screwing the screw element 6, the compensating element 1.1.4 is rotated relative to the base element 1.1.3 by means of the drive element 1.1.7 arranged between the screw element 6 and the compensating element 1.1.4 and is thus moved axially to the base element 1.1.3 from its starting position; for example, it is moved out of the base element 1.1.3 until it reaches its compensating position, in which the base element 1.1.3 and the compensation element 1.1.4 each abut one of the components 2, 8 and thus bridge the joint gap and compensate for the tolerances 200 (as shown in FIG. 9).

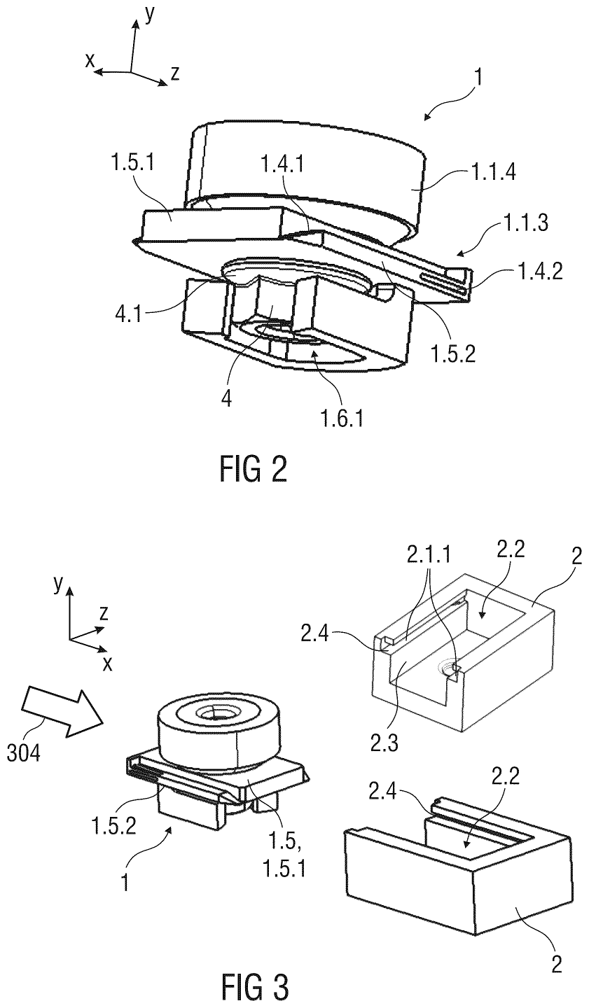

FIG. 2 schematically shows a perspectival view of the pre-assembled connecting arrangement 1. The nut element 4 is arranged in the receiving cavity 1.6.1. The nut element 4 comprises a contact flange 4.1, which rests directly on the underside of the base element 1.1.3, in particular on the underside of the retaining carriage 1.5.1. In addition, a washer can be arranged between the nut element 4 and the base element 1.1.3.

The compensating element 1.1.4 is arranged on the base element 1.1.3.

The base element 1.1.3 may comprise first coupling portions 1.4.1 as front portions and second coupling portions 1.4.2 as rear portions.

The retaining carriage 1.5.1 has guide ribs 1.5.2 on the side, on which the coupling portions 1.4, in particular the first coupling portions 1.4.1 and the second coupling portions 1.4.2, are formed.

FIG. 3 schematically shows an exploded view of the pre-assembled connecting arrangement 1 according to FIG. 2 and the first component 2.

The connecting arrangement 1 is introduced into the cavity 2.2 by means of the retaining portion 1.5 designed as a retaining carriage 1.5.1. On the side, the first component 2 has two opposite grooves 2.1.1 on its inner walls 2.3 in the form of guide grooves 2.4 for guiding the retaining carriage 1.5.1. The guide ribs 1.5.2 can be inserted into the guide grooves 2.4.

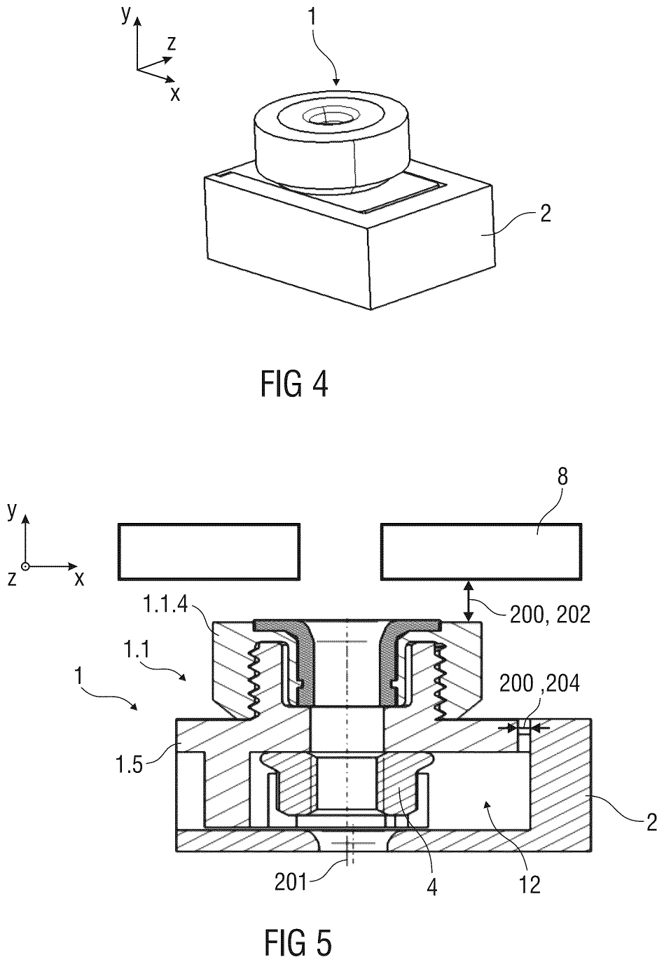

FIG. 4 schematically shows a perspectival view of the pre-assembled connecting arrangement 1, which is in turn pre-assembled on the first component 2 without play, as will be described in more detail below.

FIG. 5 schematically shows a cross-section of the connecting arrangement 1 pre-assembled on the first component 2 according to FIG. 4 and pre-positioned relative to the second component 8. The connecting arrangement 1 serves to compensate for tolerances 200.

The compensating element 1.1.4 serves to compensate for first axial tolerances 202 between the second component 8 and the first component 2 in the vertical direction y. The connecting unit 1.1 is configured to compensate for second axial tolerances 204 in the longitudinal direction x by means of the retaining portion 1.5.

For this purpose, the connecting unit 1.1 can be pre-fixable to the first component 2 so as to be axially offset 201 relative to the longitudinal axis of the first component 2.

The nut element 4 can, for example, be arranged in a free space 12 between the connecting unit 1.1 and the first component 2. The nut element 4 can be formed separately. Alternatively, the nut element 4 can be an integrated part of the connecting unit 1.1 or the first component 2.

The connecting unit 1.1 is pre-assembled on the first component 2, wherein the second axial tolerances 204 is not yet compensated for or reduced during pre-assembly. These tolerances 200 (also called gaps) are only compensated for or at least reduced when the screw element 6 (shown in FIG. 6) is screwed to the two components 2, 8 by connecting to the nut element 4.

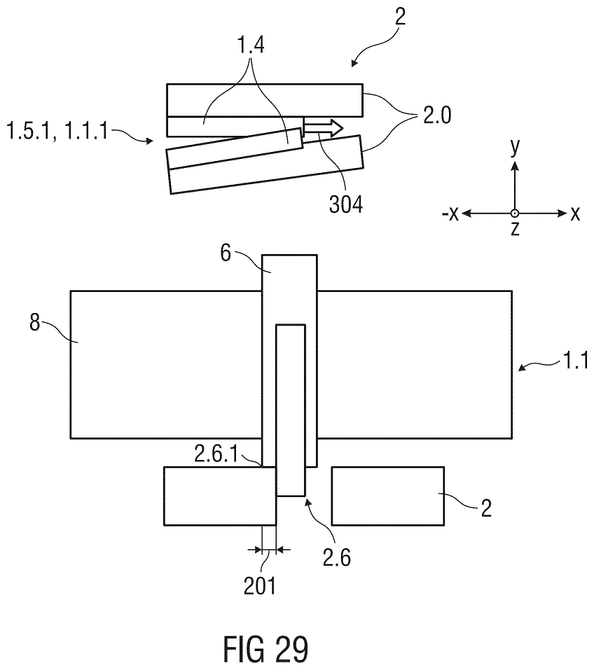

FIG. 6 schematically shows a cross-section of the insertion of the screw element 6 for connecting the two components 2 and 8 by means of the connecting arrangement 1 according to FIG. 5 and for compensating for the first axial tolerances 202 (shown in FIG. 5) between the second component 8 and the connecting unit 1.1/first component 2. Due to the previously described axial offset 201, the screw element 6 abuts at least one edge 2.6.1 of an interface opening 2.6 in the first component 2 or partially projects into this interface opening 2.6 (as is also shown in FIG. 29). As the screw element 6 is inserted further into the first component 2, the second component 8 and/or the screw element 6 is/are pressed in the direction of the interface opening 2.6 into the first component 2 for alignment, in particular centering, with respect to the interface opening 2.6. In this case, the first component 2 is pressed against the connecting unit 1.1, or, vice versa, the connecting unit 1.1 and the second component 8 are pressed against the first component 2, so that they align, in particular center, themselves with respect to one another, and will be or are positioned without play relative to one another. The first component 2 and the connecting unit 1.1 are locked together, e.g., by means of a form-fitting and/or force-fitting connection, in particular by means of a press fit.

When the two components 2, 8 are connected, the axial offset 201 (shown in FIG. 5) between the connecting unit 1.1 and the first component 2 is compensated for. The second component 8 is locked to the first component 2 via the connecting unit 1.1 in the spatial direction x of the axial offset 201. In particular, when the two components 2, 8 are connected, the second component 8 is prevented from moving in the opposite direction, in the −x-direction in particular (shown in FIG. 7), to the spatial direction x of the axial offset 201. Thus, the second component 8 can no longer be removed from, in particular pushed out of, the first component 2 in the −x-direction.

FIG. 7 schematically shows a cross-section of the connection between the connecting unit 1.1 and the first component 2, which creates a clamp, in particular a wedge clamp, when connecting the two components 2 and 8.

Due to the second axial tolerances 204, it may happen that, during connection, the screw element 6 presses against the coupling interface 1.1.1 according to arrow 300 and/or against the drive element 1.1.7 according to arrow 302.

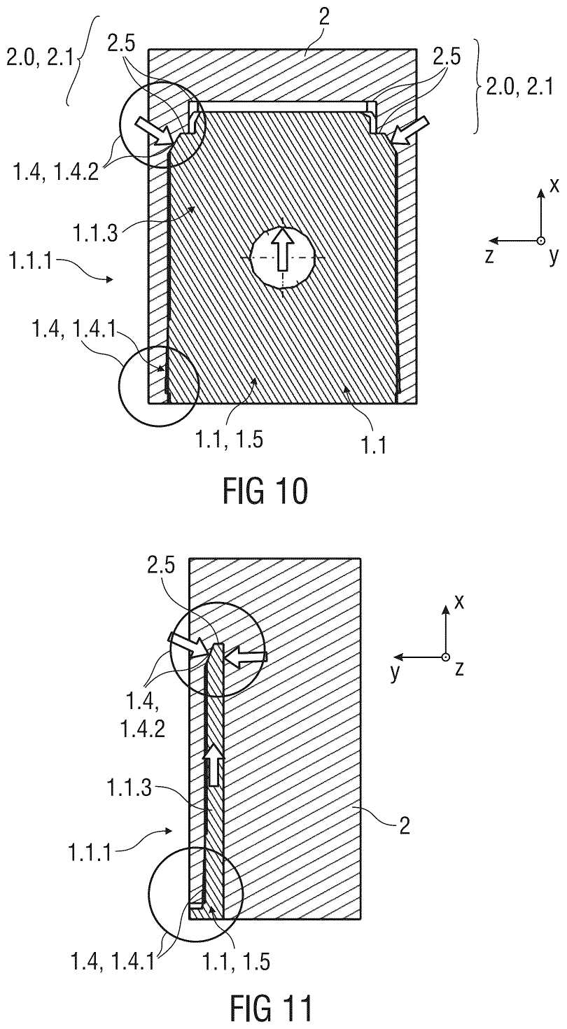

In this case, the screw element 6 presses the connecting unit 1.1 against the counter-coupling portion 2.1 in the first component 2 without play. The counter-coupling portion 2.1 is designed as an end stop 2.5 (shown in FIGS. 10 and 11). As a result, the corresponding coupling portions 1.4, 1.4.1, 1.4.2 create a form-fitting, play-free connection with the counter-coupling portions 2.1 in the first component 2 in at least two spatial directions, in particular in the transverse direction z and/or in the longitudinal direction x. Thus, the first component 2 and the connecting arrangement 1 are locked relative to and with one another so that the first component 2 cannot be moved in the longitudinal direction x. For this purpose, each counter-coupling portion 2.1 can be designed as an undercut, a step, a cut-out, a wedge, an inclined surface, an elevation, or the like.

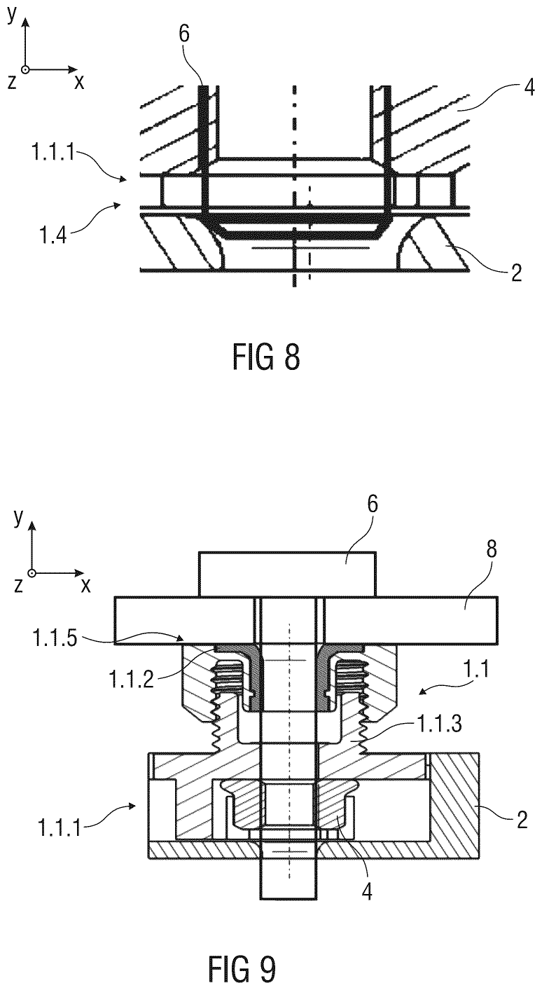

FIG. 8 schematically shows an enlarged section of the cross-section according to FIG. 7 in the region of the coupling interface 1.1.1 with the coupling section 1.4 of the connecting unit 1.1 and the first component 2, wherein the connecting arrangement 1 is clamped to the first component 2 without play and in a manner in which tolerances are compensated for.

FIG. 9 schematically shows a cross-section of the two components 2 and 8 which are connected to one another without play in a manner in which tolerances are compensated for and in which portions thereof are clamped.

A further interface 1.1.5 of the connecting unit 1.1 to the second component 8 is formed in the region of the contact surface 1.1.2 of the connecting unit 1.1.

The screw element 6 clamps the further interface 1.1.5 of the connecting unit 1.1 and the nut element 4 together.

The coupling interface 1.1.1 is not in the first force flow 400 of the screw element 6 (as shown in FIG. 17).

FIG. 10 schematically shows a sectional view of the coupling interface 1.1.1 with a plurality of coupling portions 1.4, in particular front coupling portions 1.4.1 and rear coupling portions 1.4.2, between the connecting unit 1.1, in particular its retaining portion 1.5, and the first component 2.

FIG. 11 schematically shows a further sectional view of the coupling interface 1.1.1 with the plurality of coupling portions 1.4, in particular with front coupling portions 1.4.1 and rear coupling portions 1.4.2, between the connecting unit 1.1, in particular its retaining portion 1.5, and the first component 2.

The coupling interface 1.1.1 is designed as a form-fitting, play-free connection between the connecting unit 1.1 and the first component 2, in particular as a dovetail connection between the base element 1.1.3 and the first component 2. This dovetail connection reduces creep (also called relaxation) of plastic-containing components.

For example, each coupling portion 1.4, in particular the coupling portions 1.4.1, 1.4.2, can be wedge-shaped. Each counter-coupling portion 2.1 on the first component 2 can be designed, for example, as a cut-out and/or a rear-engaging portion. In this way, a rear-engaging, in particular form-fitting, pre-connection between the connecting unit 1.1 and the first component 2 can be formed.

Each coupling portion 1.4 can, for example, be trapezoidal, wedge-shaped, L-shaped, T-shaped, dovetail-shaped, or the like. The rear-engaging portion or the cut-out in the counter-coupling interface 2.1 can, for example, be wedge-shaped, groove-shaped, dovetail groove-shaped, or the like.

In this case, the coupling portions 1.4 of the connecting unit 1.1 and the corresponding counter-coupling portions 2.1 on the first component 2 can be designed in particular such that, when the connecting unit 1.1 is assembled on the first component 2, the connecting unit 1.1 and the first component 2 are connected without play in all three spatial directions, in particular in the longitudinal direction x, vertical direction y, and transverse direction z, and thus in all three axial directions.

In particular, for this purpose, the connecting unit 1.1 is pressed into the cavity 2.2 (shown in FIG. 1) in the first component 2 in all three spatial directions as it is pre-assembled on the first component 2, so that existing tolerances 200 will be or are compensated for, and the connecting unit 1.1 is pre-assembled on the first component 2 without play and so as to be clamped and thus devoid of freedom of movement.

For example, the coupling portions 1.4 of the connecting unit 1.1 and the corresponding counter-coupling portions 2.1 on the first component 2 can be designed in particular to form a connection with one another that creates a clamp, in particular a wedge clamp—for example, a dovetail connection, an undercut connection, or the like.

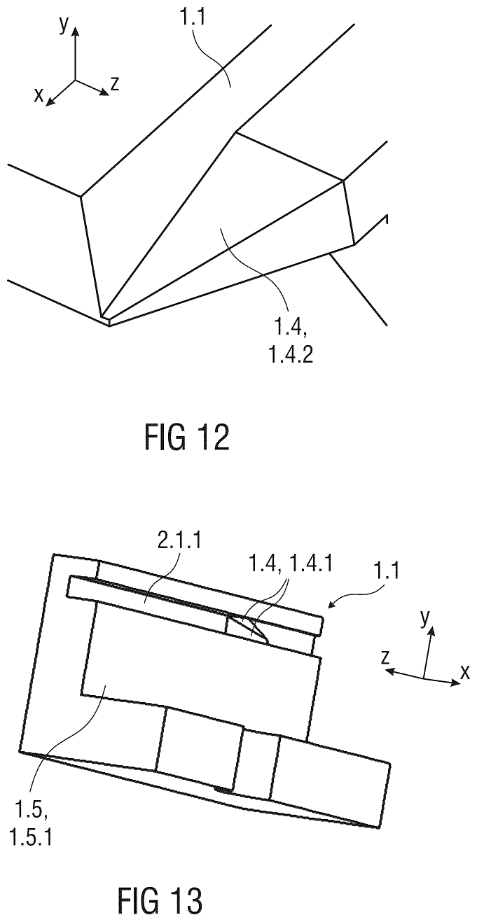

FIG. 12 schematically shows an enlarged perspectival view of a wedge-shaped coupling portion 1.4 with the wedge-shaped rear coupling portions 1.4.2 on the connecting unit 1.1. The wedge-shaped, rear coupling portions 1.4.2 serve as a counter-stop to the end stop 2.5 (shown in FIGS. 10 and 11) on the first component 2, and in particular for clamping the latter.

FIG. 13 schematically shows an enlarged perspectival view of a further wedge-shaped front coupling portion 1.4.1 on the connecting unit 1.1.

Due to the different wedge shapes of the front coupling portions 1.4.1, the first component 2 is pressed and clamped relative to the connecting unit 1.1, in particular to the retaining portion 1.5, so as to be free of play along all axes (x, y, z).

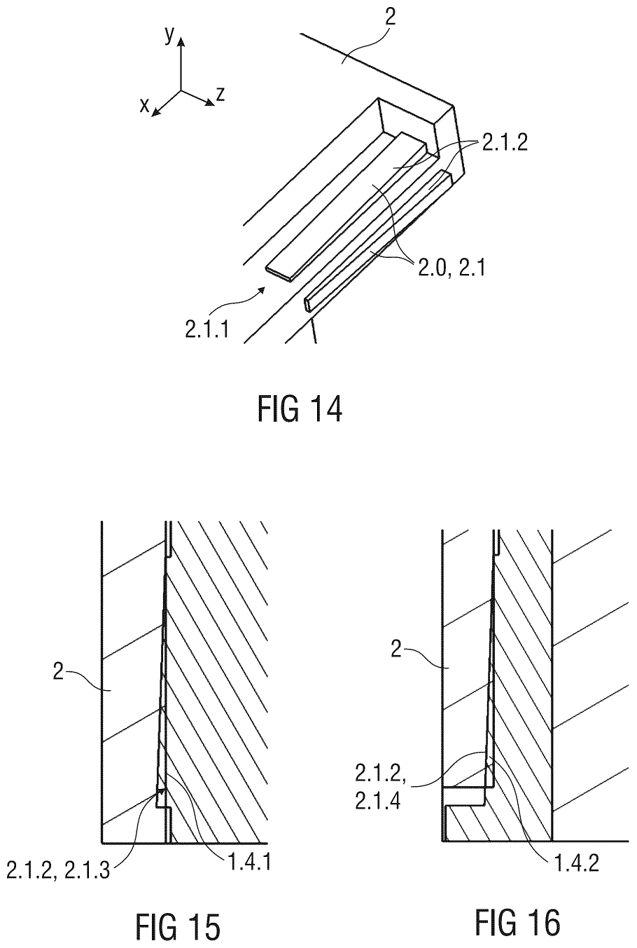

FIG. 14 schematically shows an enlarged perspectival view of a further wedge-shaped counter-coupling portion 2.1 on the first component 2. The counter-coupling portions 2.1 are formed, for example, as wedge-shaped surfaces 2.1.2 in the groove 2.1.1. The counter-coupling portions 2.1 rise from the first component 2 in the transverse direction z and in the vertical direction y. The counter-coupling portions 2.1 are in particular flexible. For example, the counter-coupling portions 2.1 can be designed as crush ribs. This easily and safely ensures there is no play.

FIG. 15 schematically shows an enlarged sectional view of the play-free, clamped connection between the first coupling portion 1.4.1 and a first counter-coupling portion 2.1.3—for example, designed as a wedge-shaped surface 2.1.2, in particular as a crush rib or flexible rising surface.

FIG. 16 schematically shows an enlarged sectional view of the play-free, clamped connection between the second coupling portion 1.4.2 and a second counter-coupling portion 2.1.4—for example, designed as a wedge-shaped surface 2.1.2, in particular as a crush rib or flexible rising surface.

FIG. 17 schematically shows a sectional view of the connected components 2 and 8 with a first force flow 400 of a preload 500 (also called clamping force) acting upon the further interface 1.1.5. The screw element 6 clamps the further interface 1.1.5 of the connecting unit 1.1 on the second component 8 and the nut element 4 together. The coupling interface 1.1.1 and thus the coupling between the connecting unit 1.1 and the first component 2 is not in the first force flow 400 of the screw element 6. The preload 500 is transferred directly from the nut element 4 to the base element 1.1.3. This reduces any possible creep or relaxation of the plastic parts.

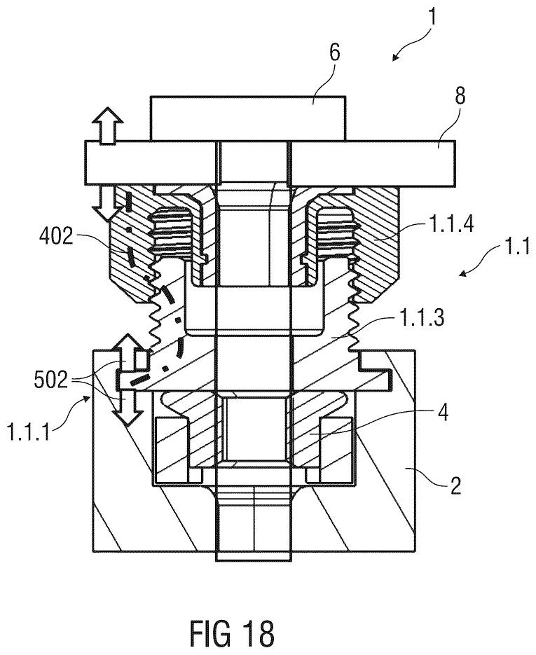

FIG. 18 schematically shows a further sectional view of the connected components 2, 8 with a second force flow 402 of an operating force 502 (also called compensating force/movement force) acting upon the coupling interface 1.1.1 between the base element 1.1.3 and the first component 2. The operating force 502 is understood to mean, in particular, forces acting upon the connecting arrangement 1 from the outside—for example, movement forces, compensating forces, or the like.

The operating force 502 is generated via the form-fitting connection, in particular a dovetail connection, between the connecting unit 1.1 and the first component 2.

The connecting arrangement 1 is designed such that all external forces acting upon the connecting arrangement 1 are transmitted via the coupling interface 1.1.1 and thus via the coupling between the connecting unit 1.1 and the first component 2, in particular via the form-fitting, play-free connection between the coupling portion 1.4, in particular the front/rear coupling portions 1.4.1, 1.4.2, and the first component 2. In other words, all external forces (also called operating forces) are absorbed by the coupling interface 1.1.1. No preload from the screw element 6 acts upon the coupling interface 1.1.1. Thus, preload loss is eliminated by including the coupling interface 1.1.1.

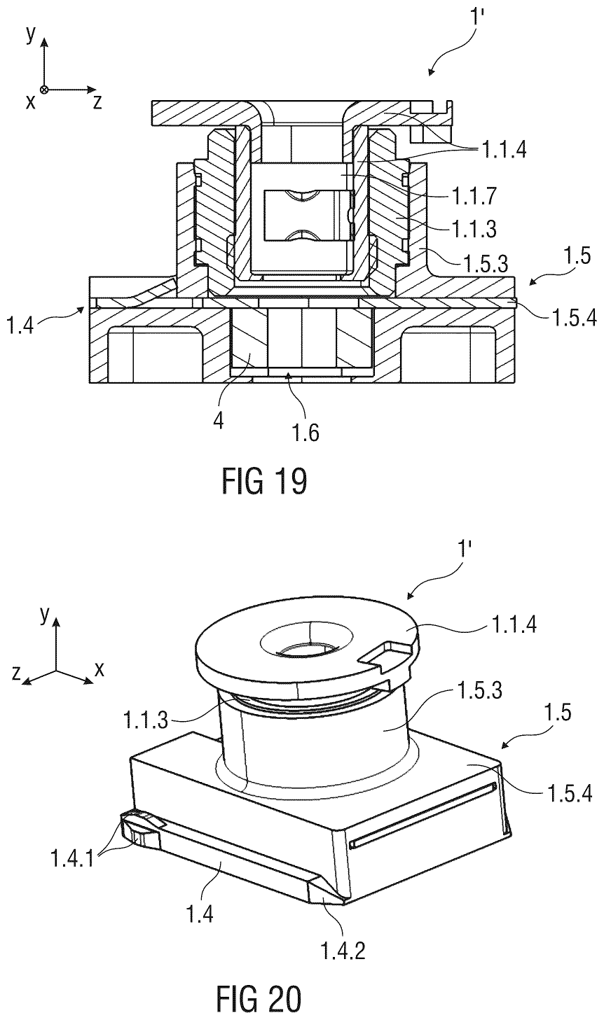

FIG. 19 schematically shows a sectional view of an alternative connecting arrangement 1′.

FIG. 20 schematically shows a perspectival view of the alternative connecting arrangement 1′ according to FIG. 19.

The alternative connecting arrangement 1′ differs in that the compensating element 1.1.4 is formed in two parts from a sleeve portion and a contact ring. The drive element 1.1.7 is designed as a spring element. The base element 1.1.3 is designed as a hollow-cylindrical element. The retaining portion 1.5 is designed as a retaining ring 1.5.3 with a plate 1.5.4 that can be fixed to the retaining ring 1.5.3. The nut element 4 is arranged and held in the receiving portion 1.6 of the retaining portion 1.5 forming the coupling portion 1.4.

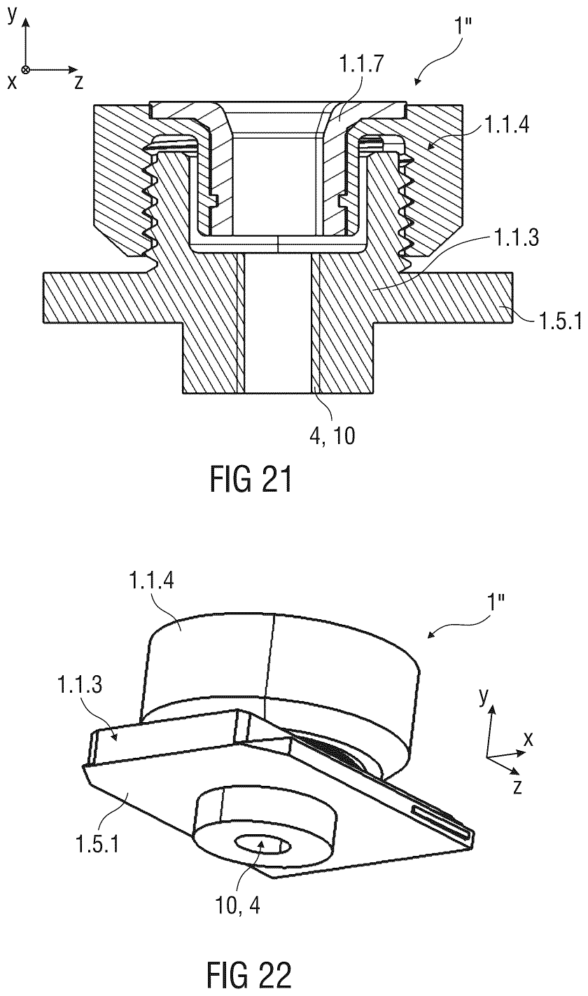

FIG. 21 schematically shows a sectional view of a further alternative connecting arrangement 1″.

FIG. 22 schematically shows a perspectival view of the further alternative connecting arrangement 1″ according to FIG. 21.

The alternative connecting arrangement 1″ differs in that the compensating element 1.1.4 is formed in one piece with a circumferential, U-shaped collar in which the drive element 1.1.7 is arranged. The drive element 1.1.7 is designed as a spring element. The base element 1.1.3 is designed as a hollow-cylindrical element with an integrated retaining carriage 1.5.1. The nut element 4 is integrated into the base element 1.1.3 as an internal thread 10.

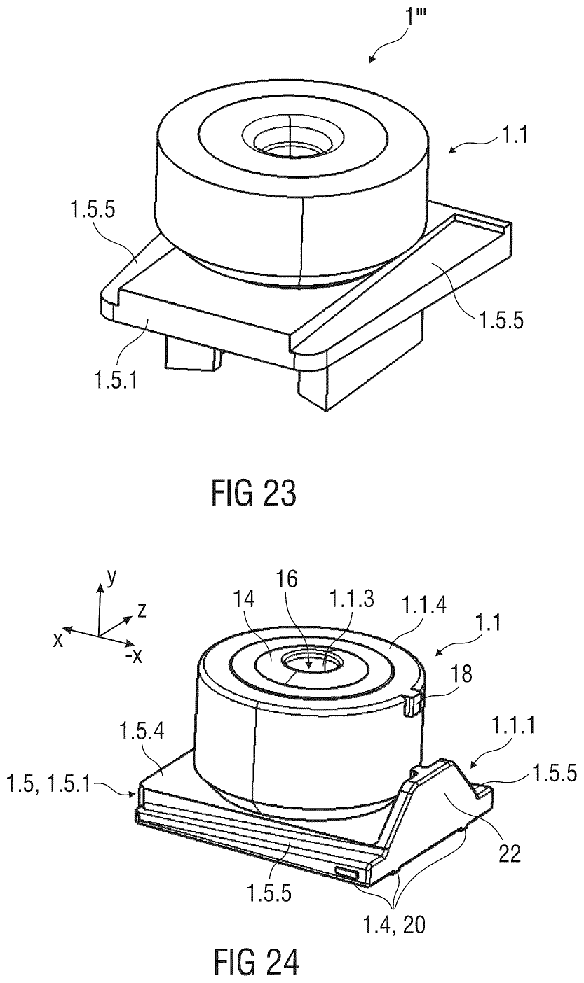

FIG. 23 schematically shows a perspectival view of a further alternative connecting arrangement 1′″.

The alternative connecting arrangement 1′″ differs in that the retaining carriage 1.5.1 has conical guides 1.5.5 for clamping and pre-connecting the connecting unit 1.1 to the first component 2 with no play.

FIG. 24 schematically shows a perspectival view of further connecting unit 1.1 with an alternative coupling interface 1.1.1.

The connecting unit 1.1 comprises, analogously to the previously described connecting units 1.1, the base element 1.1.3 and the compensating element 1.1.4.

The coupling interface 1.1.1 can be an integral part of the base element 1.1.3. Alternatively, the coupling interface 1.1.1 can be separate.

In addition, a seal 14 can be provided on the end face of the connecting unit 1.1. The seal 14 is formed, for example, from a soft plastic material, in particular from a thermoplastic elastomer (=TPE), a rubber, or another similar material. The seal 14 is arranged on the connecting unit 1.1, in particular on the base element 1.1.3, in particular in the direction of the second component 8 (shown in FIGS. 5 and 6). The seal 14 can be annular. The seal 14 can be T-shaped in cross-section and extend partially into a through-opening 16 in the base element 1.1.3. The seal 14 can be formed as a separate element. The seal 14 can be an integral part of the base element 1.1.3. For example, the seal 14 can be molded onto the base element 1.1.3.

In addition, the connecting unit 1.1 can have a stop 18. The stop 18 extends radially outwards as a projection at an end face of the connecting unit 1.1.

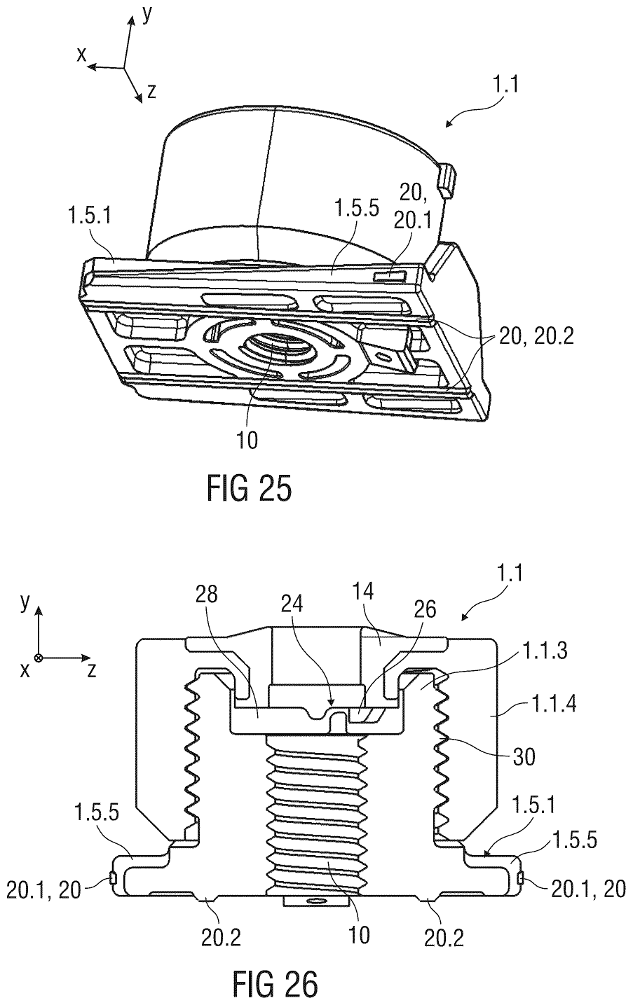

The coupling interface 1.1.1 comprises ribs 20 as coupling portions 1.4. The ribs 20 are formed, for example, on the retaining portion 1.5 in the region of the retaining carriage 1.5.1 as short side ribs 20.1 and/or on the underside as longitudinal ribs 20.2 (shown in FIG. 25). As previously described, the retaining carriage 1.5.1 can analogously have the plate 1.5.4 with lateral conical guides 1.5.5, by means of which the retaining carriage 1.5.1 can be assembled in the first component 2. The side ribs 20.1 are arranged in particular on the outside of the conical guides 1.5.5.

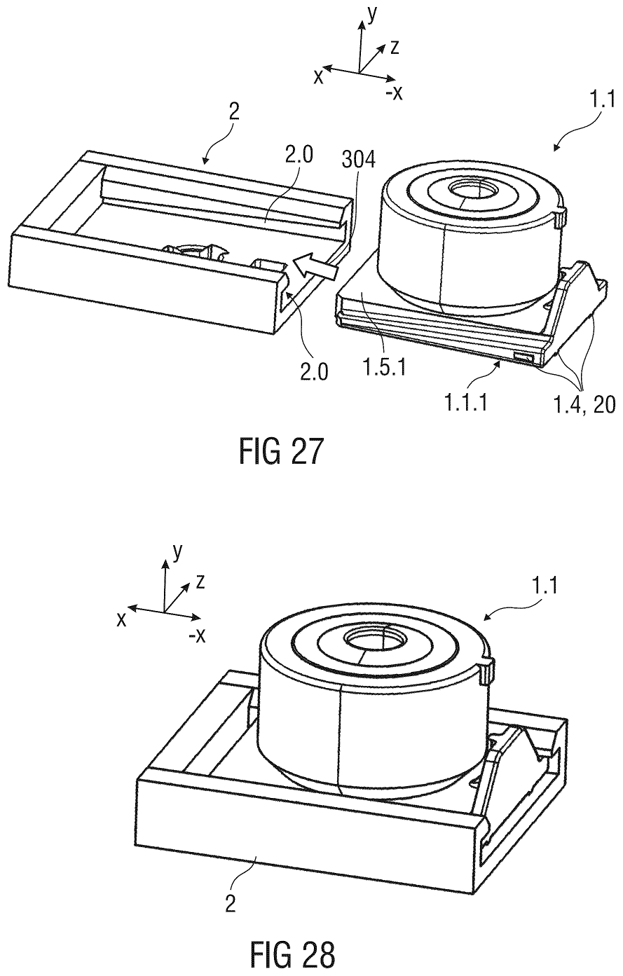

When assembled on or coupled to the first component 2 (shown in FIGS. 27 and 28), the additional ribs 20 form multiple force-fitting connections with the first component 2, in particular a press fit, a frictional connection, a clamping connection, or the like. In particular, the connecting unit 1.1 can thereby be fixed both at the bottom and at the side to the first component 2 in the assembled state; in particular, they are connected to one another with a press fit.

In addition, the connecting unit 1.1 can have a stop surface 22. The stop surface 22 extends vertically upwards from the retaining carriage 1.5.1.

FIG. 25 schematically shows another perspectival view of the further connecting unit 1.1 according to FIG. 24. FIG. 26 schematically shows a sectional view of the further connecting unit 1.1 with the base element 1.1.3 and compensating element 1.1.4, which are in threaded engagement 30 with one another.

In addition, the connecting unit 1.1 can comprise a transport lock 24 and/or an end stop 26. The transport lock 24 ensures that the base element 1.1.3 and the compensating element 1.1.4 do not separate from one another during transport. The end stop 26 serves to limit the movement of the compensating element 1.1.4 relative to the base element 1.1.3 during a compensating movement to compensate for axial tolerances 200.

The transport lock 24 and/or the end stop 26 are arranged and formed inside the connecting unit 1.1. In particular, these are formed, for example, as corresponding protruding projections, protruding noses, protruding lips, or the like in an end-face recess 28 of the base element 1.1.3 on opposite end faces of the base element 1.1.3 and the compensating element 1.1.4 or seal 14.

The side ribs 20.1 are arranged as short ribs 20 at the widening conical end of the conical guides 1.5.5. The longitudinal ribs 20.2 extend over the entire underside of the retaining carriage 1.5.1.

The connecting unit 1.1 can additionally be provided with the internal thread 10 for the screw element 6 (shown in FIG. 6).

FIG. 27 schematically shows an exploded view of the further connecting unit 1.1 according to FIG. 24 and a first component 2, on which the connecting unit 1.1 is to be pre-assembled by means of the coupling interface 1.1.1, analogously to that previously described on the basis of the other FIGS. 1 to 23. FIG. 28 schematically shows a perspectival view of the further connecting unit 1.1 and the first component 2 in the coupled state, in particular the pre-fixed state. FIG. 29 schematically shows a method sequence when connecting the second component 8 to the connecting unit 1.1 and the first component 2.

In this case, the connecting unit 1.1 is introduced, in particular pushed, into the counter-coupling interface 2.0 of the first component 2 by means of the retaining carriage 1.5.1 according to arrow 304 until the coupling portions 1.4 of the coupling interface 1.1.1 of the connecting unit 1.1 are fixed to the first component 2 in a form-fitting and/or force-fitting manner in at least two spatial directions, in particular in the longitudinal direction x and vertical direction y, in particular by means of a press fit created by the ribs 20.

FIG. 29 is a detailed view of the previously described axial offset 201, which compensates for the connection of the components 2 and 8 by moving the second component 8 and/or the screw element 6 when centering the screw element 6 on the interface opening 2.6 in the first component 2.

### LIST OF REFERENCE SIGNS

1, 1′, 1′″, 1′″ connecting arrangement
1.1 connecting unit
1.1.1 coupling interface
1.1.2 contact surface
1.1.3 base element
1.1.4 compensating element
1.1.5 additional interface
1.1.7 drive element
1.1.7.1 entraining portion
1.1.7.2 flange
1.2 tolerance-compensating element
1.4 coupling portion
1.4.1 first/front coupling portions
1.4.2 second/rear coupling portions
1.5 retaining portion
1.5.1 retaining carriage
1.5.2 guide ribs
1.5.3 retaining ring
1.5.4 plate
1.5.5 conical guide
1.6 receiving portion
1.6.1 receiving cavity
2 first component
2.0 counter-coupling interface
2.1 counter-coupling portion
2.1.1 groove
2.1.2 wedge-shaped surface
2.1.3 first counter-coupling portion
2.1.4 second counter-coupling portion
2.2 cavity
2.3 inner wall
2.4 guide groove
2.5 end stop
2.6 interface opening
2.6.1 edge of the interface opening
4 nut element
4.1 contact flange
6 screw element
8 second component
10 internal thread
12 free space
14 seal
16 through-opening
18 stop
20 rib
20.1 side rib
20.2 longitudinal rib
22 stop surface
24 transport lock
26 end stop
28 recess
30 threaded engagement
200 tolerances
201 axial offset
202 first axial tolerances
204 second axial tolerances
300 arrow
302 arrow
304 arrow
400 first power flow
402 second power flow
500 preload
502 operating force
x longitudinal direction, spatial direction, x-direction
x opposite direction,
−x-direction
y vertical direction
z transverse direction

1. A connecting arrangement for connecting two components, comprising:
at least one connecting unit, and
a nut element,
wherein the connecting unit comprises an interface for coupling to a first component,
wherein the coupling interface comprises at least two coupling portions for coupling to the first component,
wherein the connecting unit can be fixed to the first component in a form-fitting and/or force-fitting manner by means of the at least two coupling portions.

2. The connecting arrangement according to claim 1, wherein the connecting unit is fixable or fixed to the first component by means of the at least two coupling portions without play.

3. The connecting arrangement according to claim 1, wherein the connecting unit comprises at least one base element and one compensating element which is in threaded engagement with the base element in order to compensate for tolerances.

4. The connecting arrangement according to claim 1, wherein the connecting unit is fixable or fixed to the first component with an axial offset thereto.

5. The connecting arrangement according to claim 4, wherein, when connecting the two components, as a result of the axial offset, a screw element extends at least partially through the connecting unit into an interface opening in the first component and/or abuts an edge of the interface opening in the first component.

6. The connecting arrangement according to claim 4, wherein, when connecting the two components, the second component can be adjusted without play relative to the first component by means of the connecting unit and/or by means of a screw element that is introduced into the connecting unit and at least partially engages in the first component.

7. The connecting arrangement according to claim 1, wherein, when the two components are connected, the second component is locked to the first component in the spatial direction of the axial offset.

8. The connecting arrangement according to claim 1, wherein, when the two components are connected, the second component is prevented from moving in the opposite direction to the spatial direction of the axial offset.

9. The connecting arrangement according to claim 1, wherein each coupling portion is wedge-shaped.

10. The connecting arrangement according to claim 1, wherein the first component comprises a counter-coupling interface.

11. The connecting arrangement according to claim 10, wherein the coupling interface and the counter-coupling interface form a form-fitting and/or force-fitting connection when coupled.

12. The connecting arrangement according to claim 1, wherein the nut element is arranged in a free space between the connecting unit and the first component.

13. The connecting arrangement according to claim 1, wherein the nut element is an integral part of the connecting unit.

14. The connecting arrangement according to claim 1, wherein, when the two components are connected, the connecting unit and the resulting compensating element and the base element are clamped to the nut element by means of the screw element.

15. The connecting arrangement according to claim 1, wherein the connecting unit can be pre-fixed to the first component in the form-fitting and/or force-fitting manner by means of the at least two coupling portions.

16. A vehicle device having a connecting arrangement according to claim 1.
